(19) United States
(12) Patent Application Publication
(10) Pub. No.: US 2020/0333243 A1
(43) Pub. Date: Oct. 22, 2020

(54) EXHAUST GAS ANALYSIS

(71) Applicant: Nyquist Solutions Ltd, Atworth (GB)

(72) Inventors: Richard Smith, Melksham (GB); Christopher Mauruschat, Melksham (GB); Simon Phillips, Devizes (GB)

(21) Appl. No.: 16/755,507

(22) PCT Filed: Sep. 3, 2018
(86) PCT No.: PCT/EP2018/073563

§ 371 Date: Apr. 10, 2020

(30) Foreign Application Priority Data
Oct. 11, 2017 (GB) 1716620.8

(51) Int. Cl. G01N 21/3504; G01N 21/53; G01N 21/85

(52) U.S. Cl. CPC G01N 21/3504; G01N 2021/3536; G01N 21/85; G01N 21/53

(57) ABSTRACT

The invention relates to an apparatus (11) for analysing an exhaust gas of a vehicle, comprising a sample chamber (29) for receiving the exhaust gas, a heating device (24) for heating the exhaust gas provided to the sample chamber (29), and an infrared analysis device (23) having an infrared transmitter and an infrared receiver. The infrared transmitter is operable to transmit an infrared beam into the exhaust gas in the sample chamber (29), and the infrared receiver is operable to receive scattered infrared light from the exhaust gas in the sample chamber (29). The infrared analysis device (23) is operable to receive a signal from the infrared receiver and to compare it with a threshold level. A pass indication is issued if the exhaust gas is below the threshold level and a fail indication is issued if the exhaust gas is above the threshold level. The threshold level may correspond to a change in signal level equivalent to a predetermined density of particulates in the exhaust gas. The infrared receiver may be configured to generate the signal based on infrared light scattered from particles having a particle size preferably in the range 0.3 μm to 10 μm. Processing circuitry is preferably configured to operate the apparatus in a warm-up mode during a first period, during which the heater device (24) is activated. A fan (22), upstream of the sample chamber (29) and for delivering exhaust gas thereto, may be operated at one of a plurality of selectable fan speeds, the fan (22) being successively switched to higher ones of the selectable fan speeds. A method of analysing an exhaust gas is also disclosed.

### TECHNICAL FIELD

The invention relates to an apparatus for the analysis of exhaust gas (e.g. of a diesel engine), and to a method of analysis thereof. Further, the invention relates to a particle filter analysis station, for analysing the state of a particle filter, e.g. a diesel particle filter (DPF).

### BACKGROUND

Air quality in urban areas is of serious concern, particularly in relation to emissions from diesel vehicles. One important pollutant is particulate emissions in the PM2.5 (2.5 μm diameter) range and below, which are known to cause respiratory problems, especially in susceptible groups such as asthma and emphysema sufferers. The problem of particulate emissions from diesel vehicles has been known for many years; and from as early as 2005 larger diesel engines were required to have particle filters fitted in order to comply with the Euro 4 standard in EU states. In January 2011, Euro 5 was introduced in the EU states for passenger cars, which mandated the fitting of a DPF to vehicles so as to significantly reduce carbon particle emissions. Subsequently, it was a requirement in the EU that more modern Euro 6 engines also be fitted with DPFs, in order to meet the necessary homologation standards.

Thus, there is now on the road a collection of diesel vehicles up to 6 years old that require an effective DPF in order to meet their roadworthiness obligations. However, many such vehicles have experienced problems of DPFs becoming blocked, even after relatively short periods of use. A multitude of reasons have been suggested for the problem of blocked DPFs, but the consensus is that short journeys with long periods of idling can disrupt the normal process by which partially blocked DPFs can clean themselves or “regenerate”. The process of DPF “regeneration” requires very specific driving conditions to be met, e.g. to allow fuelling to be adjusted in order to raise the exhaust gas temperature to the level required to “light off” the DPF and to reduce the trapped carbon held in the ceramic matrix to ash. In the absence of regular “regeneration” operations, carbon accumulates in the core of the DPF, eventually triggering the on board monitoring system and causing the vehicle to revert to a “limp home” mode and illuminate a dashboard fault indicator. It has been reported that, rather than address the causes of the problem of blocked DPFs, one solution adopted by drivers of diesel vehicles has been to have the filtration matrix of the DPF removed or drilled to prevent the on-board system from triggering a fault condition. As most on-board DPF carbon loading systems work by measuring the increasing differential pressure drop across the filter as it fills up, drilling or removing the matrix permanently prevents “limp home” mode from being adopted/indicated.

It is known to analyse an exhaust gas stream, for example, during a vehicle inspection such as a MOT test in the United Kingdom. In order to combat the abovementioned practice of removing or drilling the DPF to prevent the on-board system from triggering a fault condition the MOT test was amended in 2014, to require “Garages and testing stations . . . to check for a diesel particulate filter (DPF) in the inspection of the exhaust system”. Unfortunately, a visual inspection of the exhaust system is not effective in determining the integrity of the DPF, as the external appearance may be unchanged.

More recently, the Department for Transport (DfT) in the UK has proposed, as part of the MOT (exhaust system) testing, lowering the opacity limit value) for the existing smoke test from 1.5 to 0.7 m⁻¹, on the basis that any vehicle with a compromised DPF will fail the new test. However, research already published has cast doubt on the correlation between opacity measurements and particulate emissions. In addition, it appears quite clear that many of the vehicles on the road at the moment that have valid MOT test certificates should have failed at the old limit of 1.5 m⁻¹, but apparently did not. The existing Free Acceleration Smoke (FAS) test used in the MOT test appears to be flawed and has been problematic since its introduction, mainly due to the requirement for the engine to be revved by the operator (tester). There will be MOT technicians testers) who know how to operate a vehicle during a test in order to get the vehicle to pass. At the same time, it is not an uncommon sight to observe a modern diesel vehicle (including Euro 5/6 compliant cars) pulling away at traffic lights and emitting black smoke as the engine is loaded. In relation to the FAS test, it appears technically infeasible that lowering the test limit will provide an effective solution for the accurate verification of DPF integrity during an MOT roadworthiness test.

To summarise, the fitment of DPFs to compliant Euro5 and Euro6 vehicles, supported by regular roadworthiness testing, should have already reduced the problem of particulate emissions to almost negligible level; however, it appears to have clearly failed to do so. There appears to be significant evidence that particle filtration systems on vehicles are being modified to overcome in service/testing problems.

Referring to a report of the UK Transport Office (Report CP17/18/770; see http://www.transportoffice.gov.uk/) entitled “Low Emission Diesel Research—Phase 3 Report” (Annex 2), this states: “However, it is likely that the use of particulate traps will become increasingly prevalent, particularly for Euro IV and later specification heavy-duty vehicles. The PM emissions from such vehicles are expected to be so low so as to be very challenging to measure, and will probably be well below the type approval standard. The requirement for in-service testing is not to measure these emissions per se but to detect defective vehicles.”

The aforementioned UK Transport Office report was part of a study done for VOSA in 2005, apparently to justify the use of existing smoke meters at MOT stations to conduct FAS testing with a reduced K value limit of L5 m⁻¹, and did conclude that they were capable. Nevertheless, the comments and results in the report clearly state that K values of <0.05 m⁻¹ would be expected from a FAS test conducted on vehicles with a functioning DPF.

The Euro 5 and Euro 6 homologation limits for total particulate emissions are 5 mg/km. While it is difficult to relate this to a smoke test, this limit is based on the assumption that a 1 m cube of air with a K value of about 0.7 m⁻¹ will prevent 50% of incident light from passing through. When it is considered that in 1 km a 2 litre diesel engine might displace approximately 2 m³, from a technical/observational point of view it appears unlikely and/or infeasible that 5 mg of carbon distributed in such a volume would absorb 50% of the incident light. To date, no attempts have been observed to establish the correlation between K value limit in the UK MOT test and DPF integrity. It appears likely that the new limit may be more related to the capabilities of existing smoke meters than a substantial effort to address the problem of air quality.

As noted in the aforementioned UK Transport Office Report CP17/18/770: “A major weakness of the FAS test was found to be the dependence of the rest result on the exact details of how the test procedure was undertaken (critically the rate and extent of accelerator depression). Halving the rate from the normal “swift rate of depression” led to changes in smoke emissions of up to 500% for HDVs and a mean change in excess of 200% far LDVs. Such large variations in FAS test result from such small changes in test procedure, particularly when combined with the poor correlation between FAS test results and PM emissions over drive cycles, seriously weakened the case for FAS testing”.

The issue of how to carry out in-service checking of the DPFs of diesel vehicles using an unloaded test is very difficult to resolve. On-road testing of particulate emissions as part of an MOT test is impractical and prohibitively expensive.

In summary, the potential lack of correlation between Type Approval and real driving conditions emissions performance is a complex problem. In addition, the dependency of MOT test results on operator involvement in the existing smoke test is also problematic: it is doubtful that existing smoke meters are sufficiently sensitive to definitively fail cars with compromised DPFs; and smoke meter-based testing has failed to improve air quality since its introduction over 20 years ago, despite repeated reductions of the MOT test pass limit. Most existing smoke meters used in MOT testing rely on opacity measurement; however, it is generally accepted that opacity measurements suffer from various problems such as poor resolution, cross sensitivity to NO₂ and insensitivity to small particles.

In relation to one specific area directly relevant to a MOT, it is known that a number of vehicles on the road today have had their DPFs compromised, resulting in excessive particulate emissions, and that these vehicles have passed existing MOT smoke tests. Properly functioning DPFs emit very little particulate matter.

There is a need for apparatus and methods that provide a simple and effective means to check, with a vehicle in an unloaded state (e.g. engine idle) whether its DPF is effective or has been compromised/removed, and without relying on legislated emissions limits (i.e. K values) or smoke tests.

It is broadly an object of the present invention to address one or more of the above mentioned disadvantages of the previously known apparatus.

### SUMMARY

What is required is an apparatus and method which may reduce or minimise at least some of the above-mentioned problems.

According to a first aspect of the invention, there is provided an apparatus for analysing an exhaust gas of a vehicle, comprising a sample chamber for receiving the exhaust gas, a heating device for heating the exhaust gas provided to the sample chamber, and an infrared analysis device having an infrared transmitter and an infrared receiver, the infrared transmitter being operable to transmit an infrared beam into the exhaust gas in the sample chamber, and the infrared receiver being operable to receive scattered infrared light from the exhaust gas in the sample chamber, wherein the infrared analysis device is operable to receive a signal from the infrared receiver and to compare it with a threshold level, and to issue a pass indication if the exhaust gas is below the threshold level or to issue a fail indication if the exhaust gas is above the threshold level.

Rather than use an opacity measurement, as most existing smoke meters do in MOT tests, the DPF testing apparatus and method according to embodiments of the invention utilises the scattering of IR radiation to provide a more direct and sensitive measurement of particle density from diesel exhaust. Such an apparatus provides the advantage that using scattering of light to detect particles below 5 μm provides a more accurate and sensitive arrangement.

In one embodiment the DPF testing apparatus and method according to embodiments of the invention provides a simple (pass/fail) and effective test of the DPF while the vehicle engine is at idle. By using a direct measurement of particle density at idle, a definitive result can be obtained very quickly. Further, as the test is carried out at idle, there is no need for any operator intervention during the test procedure.

Verifying operation of the DPF is a more practical and direct way to remove gross polluters from the road by ensuring that a given vehicle has the particulate filtration system designed for the vehicle by the manufacturer fitted and unmodified. Removal from the road of vehicles with compromised DPFs could have a significant positive effect on air quality, especially in urban areas, in a relatively short timescale.

It will be appreciated that the signal may be more than one signal or signals, e.g. a stream of signals.

Preferably, the threshold level corresponds to a change in signal level, compared to a base signal level when no exhaust gases are present in the sample chamber, equivalent to a predetermined density of particulates in the exhaust gas. An advantage is to eliminate the effects of drift and ambient light; that is, a dynamic zero is used as a baseline and only a significant differential change above that level will register as a fail. In other words the change in signal level is equivalent to the predetermined density of particulates in the exhaust gas.

The predetermined density may be in the range 0.02 to 0.5 mg/m³, or more preferably 0.04 to 0.25 mg/m³, or more preferably 0.04 to 0.125 mg/m³, or more preferably 0.04 to 0.0625 mg/m³. As the expected level of signal for a clean car is negligible, the threshold for a fail is empirically derived and hence a change in reading equivalent to approximately 0.4 mg/m⁻³ in the optical scattering at idle is considered to be indicative that the DPF is compromised. Beneficially, this enables a simple threshold level to be set, facilitating expedited pass/fail determination.

In one embodiment, the infrared receiver is configured to generate the signal based on infrared light scattered from particles in the exhaust gas having a particle size in the range 0.3 μm to 10 μm. Advantageously, the invention can be implemented with commercially available optical sensors, such as those used for tobacco smoke analysis, that are highly sensitive to particle sizes in the range 0.2 μm-0.6 μm.

Preferably, the signal is a voltage proportional to the density of particles in the exhaust gas.

Preferably, the infrared analysis device includes processing circuitry, coupled to the infrared transmitter, the infrared receiver, the heating device and a user interface. Preferably, the processing circuitry is configured to operate the apparatus in a warm-up mode during a first period during which the heater device is activated. The first period may be for example after power-on of the apparatus. An advantage is to prevent condensation from affecting the measurement, especially when the sample exhaust gas is passed over a heated surface to raise the exhaust gas temperature to above a predetermined temperature, e.g. 55° C., before entering the sensor.

Preferably, the processing circuitry is configured to operate the apparatus subsequently in a test mode for a second period, during which the processing circuitry receives the signal(s) generated by the infrared receiver.

In one embodiment, the apparatus includes, or is configured to be coupled to, a sample tube into which the exhaust gas flows, in use. Preferably, the heating device is disposed in a gas flow path between the sample tube and the sample chamber. In embodiments, the heating device includes a heat exchanger; and the heat exchanger is a heating element with a heat sink which has fins. Thus, advantageously, off-the-shelf components such as a heat sink with fins, of the type typically used on computing equipment, may be employed, thus simplifying construction.

The apparatus preferably further includes a fan, for delivering exhaust gas thereto. Preferably, the fan is disposed in the gas flow path between the sample tube and the heater device. The fan may be upstream of the sample chamber.

Preferably, the processing circuitry is further coupled to the fan; and wherein the processing circuitry is configured to operate the fan, in use, at one of a plurality of selectable fan speeds. Full speed control of the fan enables the processing circuitry to run the test process in an interactive way as readings from the sensor are continuously compared with a threshold value as the fan speed increases.

Preferably, (i) during the first period, (ii) prior to the second period and/or (iii) during a first sub-period at the beginning of the second period, the processing circuitry is configured to operate the fan at a lowest fan speed.

Preferably, during the second period, the processing circuitry is configured to switch the fan to successively higher ones of the selectable fan speeds.

Preferably, there are three selectable fan speeds, and the processing circuitry is configured to operate the fan, in use, at a lowest fan speed for a first sub-period at the beginning of the second period, at a medium fan speed for a second sub-period subsequent to the first sub-period, and at a highest fan speed for a third sub-period subsequent to the second sub-period.

Preferably the fan is stopped if the fail indication is issued. Preferably the fan is stopping at the slowest fan speed commensurate with the issuing of the fail indication.

An advantage of using a variable speed fan is that it enables the test to start at very low sample rates to ensure that very dirty vehicles do not contaminate the optical sensor/analyser, which might otherwise stop the device from working. The sensor is preferably monitored at three fan speeds and the test will terminate if the threshold is exceeded at any point in the sequence, thereby minimising the duration of the test and the ingress of material into the sensor. A further advantage is that, with the fan stopped, even with the sample pipe still inserted in the exhaust, the optical sensor/analyser is effectively isolated from the exhaust, thereby maximising the life of the sensor.

Preferably, the processing circuitry is configured to continuously calculate an average of the signal and compare the average with the threshold level to determine whether to issue the pass indication or the fail indication. An advantage is that averaging of the signal by the software ensures that transient peaks in the sensor reading will not cause a failure signal to be given (i.e. intermittent “peaks” will not fail an exhaust sample).

The apparatus preferably further includes a temperature sensor, coupled to the processing circuitry and configured to measure a temperature of the exhaust gas; wherein the first period ceases when the processing circuitry determines that the heater device has raised the exhaust gas temperature to a predetermined temperature. The predetermined temperature may be 55 degrees C.

Preferably, the user interface comprises a first indicator element, a second indicator element, a status element and a user actuatable element.

Preferably, during the first period, the user interface is presented in a first form, in which the status element is activated in a first manner. Preferably, the status element comprises a first LED, e.g. amber in colour, and in the first manner the first LED flashes.

Preferably, the second period is commenced in response to detecting actuation of the user actuatable element by a user. Preferably, the user actuatable element comprises a button. An advantage is that the user interface is as simple as possible with a single push button to start the test and an unambiguous pass or fail indication at the end, facilitating operation by the user and expedited throughput of vehicles for testing.

Preferably, between the end of the first period and the start of the second period, the user interface is presented in a second form, in which the status element is activated in a second manner. Preferably, the status element comprises a first LED, e.g. amber in colour, and in the first manner the first LED is constantly illuminated. An advantage is thus that a simple user interface is provided, and the only operator actions required are to insert the sample tube into the exhaust of a vehicle and to press the button to start the test sequence when the amber STATUS led stops flashing. There is thus provided a reliable way to check for a compromised DPF by measuring the emission of particulates in the sub 5 μm region while at the same time eliminating any operator influence on the test result.

Preferably, at the end of the second period, the user interface is presented in a third form when a pass indication is issued, in which third form the first indicator element is activated and the status element is deactivated, or in a fourth form when a fail indication is issued, in which fourth form the second indicator element is activated and the status element is deactivated.

Preferably, the first indicator element comprises a second LED, e.g. green in colour, and the second indicator element comprises a third LED, e.g. red in colour.

The exhaust gas may be a diesel exhaust gas.

In a preferred embodiment one or both of the infrared emitter and infrared detector, or the infrared analysis device comprises a removable unit. The removable unit may have an identification element. Such an arrangement provides the advantage of permitting replacement of the optical components of the apparatus with ease if required, and may also ensure compatibility and consistency of operation of the apparatus.

According to another aspect of the invention there is provided a particle filter testing station, comprising: a measurement conduit including an insertion tube for insertion into the exhaust of a vehicle at idle and, communicatively coupled to the insertion tube, an exit tube for the exhaust of gases; and an apparatus according to any of claims 1 to 32 of the appended claims; wherein the apparatus is fixedly or releasably coupled to the measurement conduit, whereby a portion of gases in the measurement conduit pass, in use, into the apparatus.

Preferably, the sample tube of the apparatus is coupled to the exit tube.

Preferably, the sample tube of the apparatus is coupled to the exit tube at an angle thereto. In a preferred embodiment the angle is 90 degrees.

Preferably, the sample tube has a smaller diameter than the exit tube. Advantageously, condensed water from the vehicle exhaust pipe passes straight through the above apparatus (or drips off the end of the vehicle exhaust pipe) without entering the sample chamber, as the “sample tube” is smaller in diameter than the vehicle exhaust pipe/exit tube.

Preferably, the particle filter testing station further comprises: a base having a planar base surface; an upright attached to the base and configured to be disposed in a substantially vertical position; and a movable support, the support being adapted to be releasably attached to the upright at one of a plurality of vertical positions thereon; wherein the support is fixedly attached to the measurement conduit and/or configured to support the apparatus. Preferably the planar base is for mounting, in use, on the ground.

Preferably, the particle filter testing station further comprises a battery housing attached to or integral with the base, the battery housing being adapted to house a battery. The battery may be a lead-acid battery.

According to another aspect of the invention there is provided a method of operating an apparatus or station according to any of claims 1 to 38 of the appended claims, the method including: sampling the exhaust gas; heating the exhaust gas prior to provision to the sample chamber; analysing the exhaust gas by transmitting with the infrared transmitter an infrared beam into the exhaust gas in the sample chamber and receiving with the infrared receiver scattered infrared light from the exhaust gas in the sample chamber; receiving with the infrared analysis device the signal from the infrared receiver; and comparing the signal with the threshold level and issuing a pass indication if the exhaust gas is below the threshold level or issuing a fail indication if the exhaust gas is above the threshold level.

According to another aspect of the invention there is provided a method of analysing an exhaust gas of a vehicle, the method comprising: providing apparatus comprising a sample chamber, a heating device and an infrared analysis device having an infrared transmitter and an infrared receiver; receiving in the sample chamber the exhaust gas; heating, using the heating device, the exhaust gas provided to the sample chamber; transmitting, using the infrared transmitter, an infrared beam into the exhaust gas in the sample chamber; receiving, using the infrared receiver, scattered infrared light from the exhaust gas in the sample chamber; receiving at the infrared analysis device a signal from the infrared receiver and comparing it with a threshold level; and issuing a pass indication if the exhaust gas is below the threshold level or issuing a fail indication if the exhaust gas is above the threshold level.

Preferably, the threshold level corresponds to a change in signal level, compared to a base signal level when no exhaust gases are present in the sample chamber, equivalent to a predetermined density of particulates in the exhaust gas. Preferably, the predetermined density is in the range 0.02 to 0.5 mg/m³, or more preferably 0.04 to 0.25 mg/m³, or more preferably 0.04 to 0.125 mg/m³, or more preferably is 0.04 to 0.0625 mg/m³.

In embodiments, the method includes generating the signal using the infrared receiver based on infrared light scattered from particles in the exhaust gas having a particle size in the range 0.3 μm to 10 μm.

Preferably, the signal is a voltage proportional to the density of particles in the exhaust gas.

Preferably, the infrared analysis device includes processing circuitry, coupled to the infrared transmitter, the infrared receiver, the heating device and a user interface.

Preferably, the method further comprises operating, using the processing circuitry, the apparatus in a warm-up mode during a first period during which the heater device is activated. The first period may be for example after power-on of the apparatus.

Preferably, the method further comprises operating, using the processing circuitry, the apparatus subsequently in a test mode for a second period, during which the processing circuitry receives the signal(s) generated by the infrared receiver.

Preferably, the method further comprises providing a sample tube into exhaust gas flows, in use.

Preferably, the method further comprises disposing the heating device in a gas flow path between the sample tube and the sample chamber.

Preferably, the method further comprises providing a fan for delivering exhaust gas thereto. Preferably, the fan is disposed in the gas flow path between the sample tube and the heater device. The fan may be upstream of the sample chamber.

Preferably, the processing circuitry is further coupled to the fan; the method further comprising operating, using the processing circuitry, the fan at one of a plurality of selectable fan speeds.

Preferably, the method further comprises (i) during the first period, (ii) prior to the second period and/or (iii) during a first sub-period at the beginning of the second period, operating the fan at a lowest fan speed using the processing circuitry.

Preferably, the method further comprises, during the second period, switching the fan to successively higher ones of the selectable fan speeds using the processing circuitry.

Preferably, there are three selectable fan speeds, and the method comprises operating, using the processing circuitry, the fan at a lowest fan speed for a first sub-period at the beginning of the second period, at a medium fan speed for a second sub-period subsequent to the first sub-period, and at a highest fan speed for a third sub-period subsequent to the second sub-period.

Preferably, the method further comprises, using the processing circuitry, to continuously calculate an average of the signal and compare the average with the threshold level to determine whether to issue the pass indication or the fail indication.

Preferably, the method further comprises providing a temperature sensor coupled to the processing circuitry; wherein the method further comprises, using the processing circuitry, measuring a temperature of the exhaust gas and determining that the first period has ceased when it is determined that the exhaust gas has reached a predetermined temperature. The predetermined temperature may be 55 degrees C.

Preferably, the user interface comprises a first indicator element, a second indicator element, a status element and a user actuatable element.

Preferably, the method further comprises presenting the user interface in a first form, in which the status element is activated in a first manner. Preferably, the status element comprises a first LED, e.g. amber in colour, and in the first manner the first LED flashes.

Preferably, the method further comprises detecting actuation of the user actuatable element by a user; wherein the second period is commenced in response to said actuation. Preferably, the user actuatable element comprises a button.

Preferably, the method further comprises, between the end of the first period and the start of the second period, presenting the user interface in a second form, in which the status element is activated in a second manner. Preferably, the status element comprises a first LED, e.g. amber in colour, and in the first manner the first LED is constantly illuminated.

Preferably, the method further comprises, at the end of the second period, presenting the user interface in a third form when a pass indication is issued, in which third form the first indicator element is activated and the status element is deactivated, or in a fourth form when a fail indication is issued, in which fourth form the second indicator element is activated and the status element is deactivated. Preferably, the first indicator element comprises a second LED, e.g. green in colour, and the second indicator element comprises a third LED, e.g. red in colour.

The exhaust gas may be a diesel exhaust gas.

Preferably the method further includes stopping the sampling of the exhaust gas if the fail indication is issued. Preferably method further includes stopping the sampling of the exhaust gas by stopping the fan. Preferably the method further includes stopping the fan at the slowest fan speed commensurate with the issuing of the fail indication.

According to another aspect of the invention there is provided a software application operable to perform a method according to any of the appended claims.

Any preferred or optional features of one aspect or characterisation of the invention may be a preferred or optional feature of other aspects or characterisations of the invention.

### BRIEF DESCRIPTION OF THE DRAWINGS

Other features of the invention will be apparent from the following description of preferred embodiments shown by way of example only with reference to the accompanying drawings, in which;

FIG. 1 shows a perspective view of a vehicle particle filter testing station according to an embodiment of the invention, incorporating an exhaust gas analysis apparatus;

FIG. 2 shows a perspective sectional view of a part of the apparatus shown in FIG. 1;

FIG. 3 shows a schematic cross section view of the part of the apparatus of FIG. 2;

FIG. 4 shows a schematic view of an analysis chamber of the apparatus shown in FIGS. 2 and 3;

FIG. 5 shows a view of a display device for the apparatus according to an embodiment of the invention; and

FIG. 6 shows steps of a method according to an embodiment of the invention.

### DETAILED DESCRIPTION

The purpose of the DPF testing apparatus and method according to embodiments of the invention is to verify that particle emissions from a diesel engine fitted with a DPF are below a threshold level which indicates that the filtration system (i.e. DPF) has not been compromised. The DPF testing apparatus and method according to embodiments of the invention outputs a pass/fail based on whether the threshold level (i.e. mass equivalent thereof) is below/above PM2.5. The DPF testing apparatus and method according to embodiments of the invention measures a voltage from the sensor that is indicative of a malfunction of a DPF or a missing DPF. Realistically, at idle with a functional DPF, there should be infinitesimal levels of particulate emissions and this is evidenced by the inventors' own testing. Even Euro 5 cars, which are considered to be “clean”, barely register above the background level at idle during the test.

The purpose of the DPF testing apparatus and method according to embodiments of the invention is not to replace the abovementioned FAS test, but to add a functional check of the particulate filtration system (DPF) to replace the visual inspection, which is often ineffective. By using a direct measurement of particle density at idle, when it could be said that in theory “nothing but gas” should be coming out of the exhaust of a diesel engine with a DPF, a definitive result can be obtained very quickly.

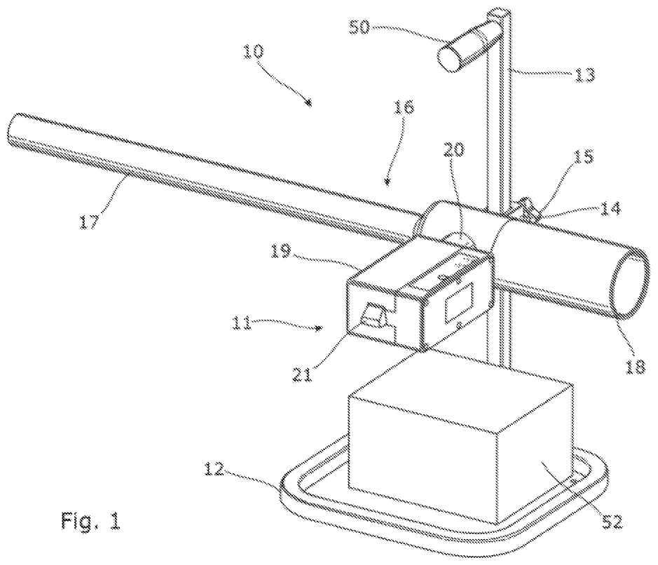

FIG. 1 shows a perspective view of a vehicle particle filter or DPF testing station, generally designated 10, according to an embodiment of the invention, incorporating an exhaust gas analysis apparatus generally designated 11.

In this embodiment, the DPF testing station 10 comprises a portable test stand comprising a base 12 having a flat under-surface (not shown) for stably supporting the DPF testing station 10 on the ground, in use, as well as an upright 13 and cooperating support 14 slidably mounted on and height adjustable with respect to the upright 13. To provide an indication of scale of the testing station 10, the upright 13 may be about 80 cm in height. The support may be fixed in position at a height suitable for the exhaust pipe of the vehicle being tested through manual operation of screw-threaded handle 15. The test stand comprises a carrying handle 50, facilitating deployment of the DPF testing station 10. Further, the base 12 may include a battery housing 52 for receiving a battery, e.g. a lead acid cell, which functions to power the exhaust gas analysis apparatus 11. Advantageously, the battery also acts as a counterweight to help stabilise the apparatus 11. Together with the battery 52 the testing station 10 may be about 12.5 Kg in mass.

The DPF testing station 10 further comprises a measurement conduit, generally designated 16 that includes a flexible insertion tube 17 (e.g. made of rubber) for insertion into the vehicle exhaust and coupled thereto, an exit tube 18, the latter being of larger diameter than the insertion tube 17.

In this embodiment, the support 14 is fixedly attached to the exit tube 18. In other embodiments, the support 14 may be formed integrally with, or be releasably attached to, the exit tube 18.

The apparatus 11 comprises a small plastic enclosure 19, fixedly or releasably attached to the exit tube 18 via a sample tube 20, in which optical components for exhaust gas analysis are housed, as will be described in detail below. The plastic enclosure 19 may include an exhaust outlet 21, i.e. for condensed water or exhaust gas.

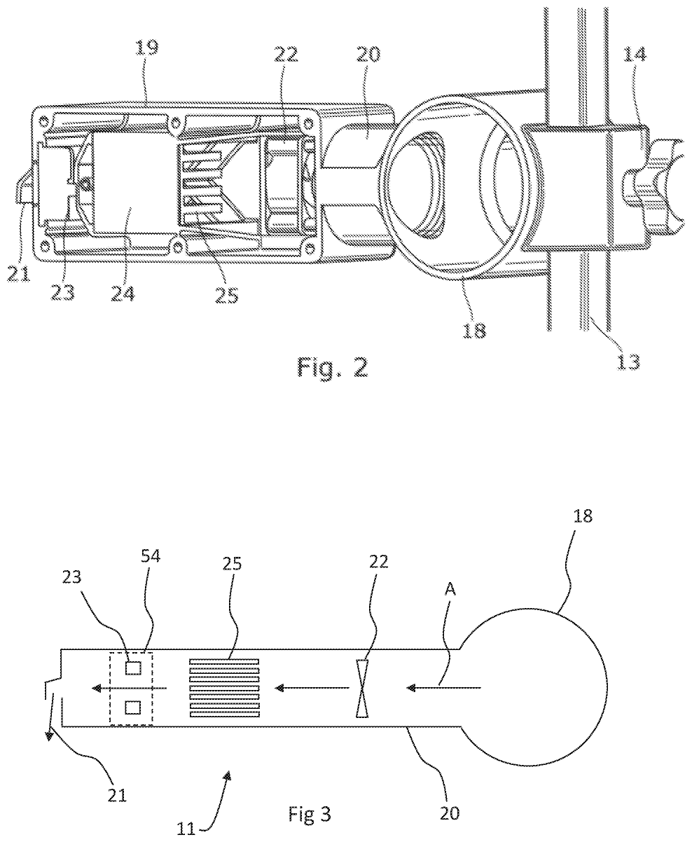

FIG. 2 shows a perspective sectional view of a part of the DPF testing station 10 shown in FIG. 1. In FIG. 2 like features to the arrangements of FIG. 1 are shown with like reference numerals. In FIG. 2, the exhaust gas analysis apparatus 11 and exit tube 18 are shown partially cut-away.

A variable speed fan 22 in the enclosure 19 is used to draw a small amount of exhaust gas out of the exit tube 18 and through the sample tube 20, which is perpendicular to the flow, and thereafter into an optical sensor 23 (including a sample chamber; not shown). In other embodiments, the sample tube may be at an acute angle to the axis of exit tube 18, and not perpendicular.

To prevent condensation from affecting the measurement, the sample exhaust gas is passed through a heater device 24, in which the sample exhaust gas is passed over a heated surface, e.g. of a heat exchanger 25 within the heater device, to raise the temperature of the sample exhaust gas to above a predetermined temperature, e.g. 55° C., before entering the sample chamber (not shown). The heat exchanger 25 may comprise fins as shown through which the sample exhaust gas passes. It will be understood that the heat exchanger is required to heat the exhaust gas in the sample chamber so that it is above a dew point thereof to inhibit condensation.

In use, most of the exhaust gas flows straight through the exit tube 18 and only a small amount is blown by the fan 22 across or through the heat exchanger 25, through the optical sensor 23 and out through the enclosure 19 at the rear. The heat exchanger 25 is preferably a heating element with a heat sink which has fins, such as typically used on computing equipment. Condensed water from the vehicle exhaust pipe (not shown) passes straight through the above apparatus 11 (or drips off the end of the vehicle exhaust pipe) without entering the sample chamber (not shown) because the sample tube 20 is smaller in diameter than the vehicle exhaust pipe/exit tube 18. Any condensed water collects at the lower inside surface of the exit tube 18 and does not enter the sample tube 20 because the sample tube 20 is above the lower surface of the exit tube 18.

FIG. 3 shows a schematic cross section view of the part of the DPF testing station 10 of FIG. 2, including the apparatus 11. In FIG. 3 like features to the arrangements of FIGS. 1 and 2 are shown with like reference numerals. In FIG. 3, it can be seen that the sample exhaust gas is tapped from the exit tube 18 and travels, as indicated by arrows A, through the sample tube 20, driven by the action of the fan 22, through to and over the heat exchanger 25 and, in heated form, to the optical sensor 23, before exiting the apparatus 11 at exhaust outlet 21.

In one arrangement the optical sensor 23 may be mounted in a removable unit or cassette 54. The removable unit 54 may be alternatively termed a replaceable unit and is a useful feature because it permits the optical sensor 23 to be readily replaced if required. The removable unit 54 is a plug-in optical assembly that would permit a qualified engineer to replace the optical sensor 23 with ease if required. The optical sensor 23 may also have an identification element such as an identification chip (e.g. a Radio Frequency identification chip or similar) to ensure compatibility and consistency of operation of the apparatus 11.

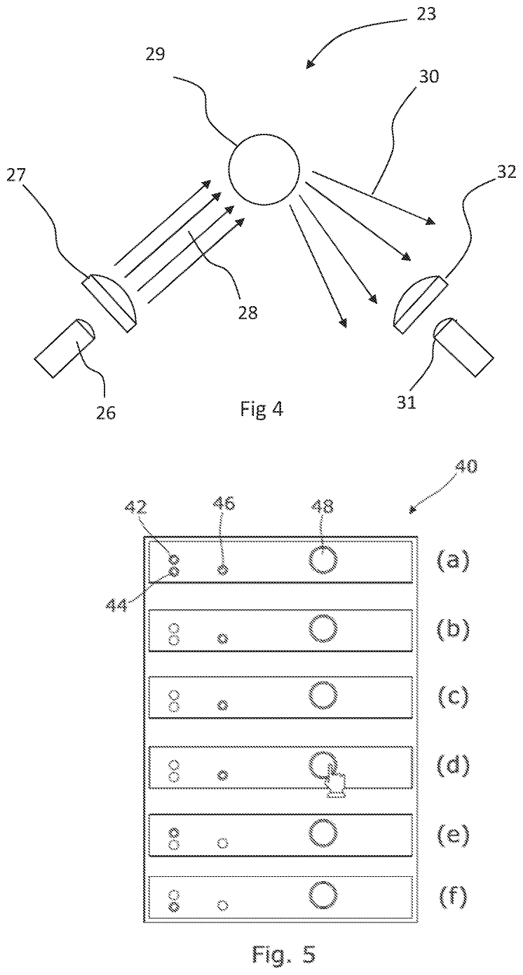

FIG. 4 shows schematically the operation of the optical sensor 23 of FIG. 3. As mentioned, the optical components are housed in a small plastic enclosure 19 which includes an IR emitter 26 and lens 27 producing a collimated beam 28 of IR radiation directed towards the circular aperture or sample chamber 29 where exhaust gas including smoke particles enter the optical sensor 23. Particles present in the sample chamber 29 scatter the incoming IR radiation in the collimated beam 28 back as scattered radiation 30 towards an IR detector 31 via focussing lens 32, with an intensity proportional to the particle density. It will be understood from the foregoing that the removable unit 54 (se FIG. 3) may comprise one or both of the IR emitter 26 or detector 31 or the complete optical sensor 23.

Particles in the region 0.10 μm to 10 μm strongly scatter IR radiation, resulting in an analogue signal output (i.e. output voltage) from the IR detector 31 of optical sensor 23. The detector is operable to detect a particle density in the range 0.02 mg/m³-0.5 mg/m³ and an exhaust gas having a particle density in this range causes a significant change in voltage from the detector. The electronic circuitry of the detector has a selectable gain setting to increase sensitivity if required. A predefined level within the measurement range is used to quantify the efficiency of the DPF on the vehicle so that the pass/fail determination can be made. In this embodiment a gain setting of 1 corresponds to a particle density in the range 0.02-0.50 mg/m³, a gain setting of 2 corresponds to a particle density in the range 0.04 to 0.25 mg/m³, a gain setting of 4 corresponds to a particle density in the range 0.04 to 0.125 mg/m³, and a gain setting of 8 a particle density in corresponds to the range 0.04 to 0.0625 mg/m³.

Diesel particulate matter typically has a bimodal distribution of particle size (i.e. particle diameter) with a large peak at around 0.01 μm (nanoparticles) and a second broader peak ranging from 0.1 μm to 1 μm (fine/ultrafine particles). In the present embodiment, it is the second peak that the sensor is most sensitive to as it is suitably configured to detect particle sizes in the range 0.3 μm to 10 μm, and more preferably in the range 0.2 μm-0.6 μm; such devices are available as off-the-shelf detectors and are used for smoke detection in other fields. In effect, the apparatus 11 acts to detect particles in the exhaust gas. It will be understood that the IR detector has a variable sensitivity to particles in the diameter range 0.3 μm to 10 μm and therefore produces an output which is proportional to the density of the ensemble of particles in the exhaust. A fully working DPF should remove substantially all of the particles in this aforementioned range of particle sizes resulting in a very small signal from the optical sensor if the DPF is present and functioning correctly. The use of available optical sensors, such as those used for tobacco smoke detection, is an advantageous implementation of the invention in a manner that is suitable for use in garage workshops. It will be understood in the description of preferred embodiments of the invention that no attempt is made to select a particle size to be detected by the IR detector other than the natural effect of gravity in the transport of particles through the apparatus.

A raw analogue signal from the optical sensor 23 is conditioned and fed to processing circuitry, such as a microcontroller (not shown), within enclosure 19. The microcontroller also generates the specific pulse drive required for the IR emitter 26. A temperature sensor (not shown) within enclosure 19 and PWM output are utilised to heat the heat exchanger 25, which is preferably a high surface area metal heat exchanger, to raise the sample exhaust gas temperature to the required 55° C.; and the sampled exhaust gas passes over the heat exchanger 25 en route to the optical sensor 23.

The microcontroller (not shown) is preferably coupled to the fan 22 (FIGS. 2 and 3), and full speed control of the fan 22 enables the microcontroller to run a test process in an interactive way, as readings from the optical sensor 23 are preferably continuously compared with a threshold value as the fan speed increases. Preferably, averaging of the signal by software ensures that transient peaks in the sensor reading will not cause a failure signal to be given (i.e. intermittent “peaks” will not fail an exhaust sample).

Using a variable speed fan 22 (see FIGS. 2, 3) enables a test to start at very low sample rates (i.e. low fan speeds) to ensure that very dirty vehicles do not contaminate the optical sensor 23, which might otherwise stop the apparatus 11 from working. The optical sensor 23 is preferably monitored at three fan speeds and the test terminates (e.g. the fan is switched off) if the threshold is exceeded at any point in the sequence to minimise the ingress of material into the optical sensor 23. With the fan stopped, even with the sample pipe 17 still inserted in the exhaust, the optical sensor 23 is effectively isolated from the exhaust, thereby maximising the life of the optical sensor 23. However, to maximise life, preferably the sample pipe 17 is removed at the end of the test.

To eliminate the effects of drift and ambient light, a dynamic zero is used as a baseline and only a significant differential change above that level will register as a fail. As the expected level of signal for a clean car is negligible, the threshold for a fail is empirically derived and hence, in embodiments, a change in reading equivalent to approximately 0.4 mg/m⁻³ in the optical scattering at idle is considered to be indicative that the DPF is compromised.

The test process will now be described. First, the vehicle engine is started and set to idle and preferably allowed to reach normal operating temperature before the insertion tube 17 is introduced into the vehicle exhaust pipe. As the test is carried out at idle, there is no need for any operator intervention during the test process.

In embodiments, the apparatus 11 may include a wireless communication subsystem and antenna (both not shown), for wireless (e.g. WiFi/cellular/Bluetooth etc) communication with a network (not shown). In this way, the test result may be communicated (e.g. in association with the vehicle's official/registration number, to a remote location of server, e.g. for recordal in a vehicle database.

FIG. 5 shows forms of user interface 40 presented to the user at various stages during the test process. (As used herein, forms 40-1 to 40-n of the user interface may collectively be designated 40.) In an embodiment, a (software) user interface 40 is provided in a display (e.g. LCD) (not shown) on the enclosure 19, but the user interface 40 may be provided in any suitable manner, such as through the use of illuminable elements (e.g. LEDs) and physical push buttons. Thus, while the “user interface” as used herein may be construed in the sense of a software-controlled virtual display of graphical elements, this expression also refers to a collection of physical and electrical elements configured to alert or inform a user, or receive inputs/commands therefrom. In embodiments, “indicator elements” as used herein may be implemented as sonic tones provided by a loudspeaker (not shown).

Preferably, the user interface 40 is as simple as possible, with a single push button to start the test and an unambiguous pass or fail indication at the end. Thus, in this embodiment, the user interface 40 comprises a first indicator element 42 (e.g. LED) having a first colour, as well as a second indicator element 44 (e.g. LED) having a second colour, e.g. red. To the right is a status indicator 46 (e.g. LED) having a third colour, e.g. amber. Finally, to the right of the status indicator 46 is a single START button (push button) 48, for actuation by a user, as will be discussed hereinafter.

Initially, after power-on, e.g. using a power or reset button (not shown) on the enclosure 19 (FIG. 1), the user interface 40-1 is displayed in the form shown in FIG. 5(a). Here, first indicator element 42, the second indicator element 44 and the status indicator 46 are constantly illuminated.

It is necessary for the internal heater device 24 (FIG. 2) to be up to temperature before the test can proceed and during this “warm-up” period the amber STATUS LED (status indicator 46) flashes, while the first indicator element 42 and the second indicator element 44 are non-illuminated, as shown in the form of user interface 40-2 of FIG. 5(b). At the end of the warm up period, the amber LED (status indicator 46) is switched to fully on (constantly illuminated), while the first indicator element 42 and the second indicator element 44 are non-illuminated, to thereby indicate the apparatus 11 is ready for testing, as shown in the form of user interface 40-3 of FIG. 5(c).

From this point, a single operation of the START button 48 then initiates the test process. Thus, all that is required is for the user to press the START button 48 and wait for a predetermined test period, e.g. approximately 30 seconds, for the test to complete. During this test period, the amber LED (status indicator 46) is constantly illuminated, while the first indicator element 42 and the second indicator element 44 are non-illuminated, as shown in the form of user interface 40-4 of FIG. 5(d).

At the end of the test period, depending upon whether the signal provided by the optical sensor 23 (FIG. 3) is below or above the predetermined threshold level,
(i) the form of user interface 40-5 of FIG. 5(e), in which the first indicator element 42 (green LED) is illuminated, while the second indicator element 44 and the amber LED (status indicator 46) are non-illuminated, is presented to the user, or
(ii) the form of user interface 40-6 of FIG. 5(f), in which the second indicator element 44 (red LED) is illuminated, while the first indicator element 42 and the amber LED (status indicator 46) are non-illuminated, is presented to the user.

Thus, at the end of the test, the user is able to simply observe the green PASS or red FAIL indicators.

In diesel vehicle exhausts, at idle, the expected level of particulate emissions is negligible if the DPF is operational; that is, nothing but gas should be coming out. The DPF testing apparatus according to embodiments of the invention can measure particulate levels quickly and indicate the result as a RED or GREEN light. The only operator intervention required is to press the START button and wait 20-30 seconds for the test to complete.

The most reliable way to check for a compromised DPF is to measure the emission of particulates in the sub 5 μm region. At the same time, it is desirable to eliminate any operator influence on the test result. The DPF testing apparatus according to embodiments of the invention has been designed to detect particulate emissions in a static test at idle using scattering of Infra Red radiation in an optical cell.

It is noted that the disclosed embodiments of the invention do not rely on any relation of the exhaust emission readings to legislated emissions limits (i.e. K values); consequently, the DPF testing apparatus according to embodiments of the invention issues only a simple PASS/FAIL. Accordingly, the embodiments do not determine if a vehicle is adhering to legislated emissions limits, but determines whether the DPF is present or damaged. The DPF testing apparatus according to embodiments of the invention also has the advantage that it cannot be manipulated by the MOT tester/technician.

The apparatus 11 is battery powered from a sealed lead acid cell housed in the base 12 of the unit and which can be recharged overnight. Given the low duty cycle of testing in an MOT bay (e.g. two or three tests every 45 minutes as a maximum) and the short duration of the test process, in normal use there should be no need to recharge the battery during the day. Ambient temperature will have significant effect on battery life, as most of the current is taken to raise and maintain the temperature of the internal heat exchanger 25. A separate mains charger may be provided with the particle filter testing station, and this can also function as a mains power supply, if necessary. The life of the optical sensor 23 is dependent on minimising exposure to very dirty exhaust, but based on reasonable use in an MOT bay, it is expected that the optical sensor 23 will function for approximately two years.

In-service calibration of the optical sensor 23 would have to be carried out by a specialist engineer and require the use of approved specialist equipment.

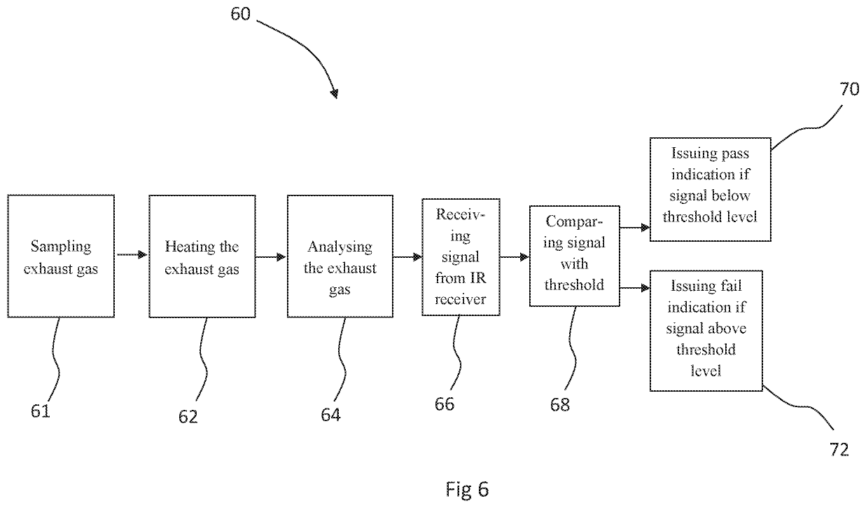

FIG. 6 shows steps of a method according to an embodiment of the invention, generally designated 60. It will be appreciated that the steps may be performed in a different order, and may not necessarily be performed in the order shown in FIG. 6. The method commences with sampling the exhaust gas (step 61). Thereafter, the exhaust gas is heated (step 62) prior to provision to a sample chamber. Next, the exhaust gas is analysed (step 64) by transmitting with the infrared transmitter an infrared beam into the exhaust gas in the sample chamber and receiving with the infrared receiver scattered infrared light from the exhaust gas in the sample chamber. The infrared analysis device then receives (step 66) a signal from the infrared receiver corresponding to the amount of scattered radiation and thus to the amount of particulates in the sample exhaust gas. Next, the signal is compared (step 68) with the threshold level and a pass indication issued (step 70) if the signal for the exhaust gas is below the threshold level or a fail indication issued (step 72) if the signal for the exhaust gas is above the threshold level.

The method described herein may be performed by a software application when run on a computer device, for example incorporating the microcontroller described above together with ancillary computer components as required. It will be understood that the embodiments described herein look for particles in the exhaust gas and issues a pass or fail indication of the exhaust gas.

1. An apparatus for analysing an exhaust gas of a vehicle, comprising a sample chamber for receiving the exhaust gas, a heating device for heating the exhaust gas provided to the sample chamber, and an infrared analysis device having an infrared transmitter and an infrared receiver, the infrared transmitter being operable to transmit an infrared beam into the exhaust gas in the sample chamber, and the infrared receiver being operable to receive scattered infrared light from the exhaust gas in the sample chamber, wherein the infrared analysis device is operable to receive a signal from the infrared receiver and to compare it with a threshold level, and to issue a pass indication if the exhaust gas is below the threshold level or to issue a fail indication if the exhaust gas is above the threshold level.

2. An apparatus according to claim 1, wherein the threshold level corresponds to a change in signal level, compared to a base signal level when no exhaust gases are present in the sample chamber, equivalent to a predetermined density of particulates in the exhaust gas.

3. An apparatus according to claim 2, wherein the predetermined density is in the range 0.02 to 0.5 mg/m³, or more preferably 0.04 to 0.25 mg/m³, or more preferably 0.04 to 0.125 mg/m³, or more preferably 0.04 to 0.0625 mg/m³.

4. An apparatus according to claim 1, 2 or 3, wherein the infrared receiver is configured to generate the signal based on infrared light scattered from particles in the exhaust gas having a particle size in the range 0.3 μm to 10 μm

5. An apparatus according to any of the preceding claims, wherein the signal is a voltage proportional to the density of particles in the exhaust gas.

6. An apparatus according to any of the preceding claims, wherein the infrared analysis device includes processing circuitry, coupled to the infrared transmitter, the infrared receiver, the heating device and a user interface.

7. An apparatus according to claim 6, wherein the processing circuitry is configured to operate the apparatus in a warm-up mode during a first period during which the heater device is activated.

8. An apparatus according to claim 7, wherein the processing circuitry is configured to operate the apparatus subsequently in a test mode for a second period, during which the processing circuitry receives the signal(s) generated by the infrared receiver.

9. An apparatus according to any of the preceding claims, including or configured to be coupled to a sample tube into which the exhaust gas flows, in use.

10. An apparatus according to claim 9, wherein the heating device is disposed in a gas flow path between the sample tube and the sample chamber.

11. An apparatus according to any of the preceding claims, further including a fan for delivering exhaust gas thereto.

12. An apparatus according to claim 11, when dependent upon claim 10, wherein the fan is disposed in the gas flow path between the sample tube and the heater device.

13. An apparatus according to claim 11 or 12, when dependent upon claim 6, wherein the processing circuitry is further coupled to the fan; and wherein the processing circuitry is configured to operate the fan, in use, at one of a plurality of selectable fan speeds.

14. An apparatus according to claim 13, when dependent upon claim 7 or 8, wherein (i) during the first period, (ii) prior to the second period and/or (iii) during a first sub-period at the beginning of the second period, the processing circuitry is configured to operate the fan at a lowest fan speed.

15. An apparatus according to claim 13, when dependent upon claim 8, wherein during the second period, the processing circuitry is configured to switch the fan to successively higher ones of the selectable fan speeds.

16. An apparatus according to claim 15, wherein there are three selectable fan speeds, and the processing circuitry is configured to operate the fan, in use, at a lowest fan speed for a first sub-period at the beginning of the second period, at a medium fan speed for a second sub-period subsequent to the first sub-period, and at a highest fan speed for a third sub-period subsequent to the second sub-period.

17. An apparatus according to any of claims 11 to 16, wherein the fan is stopped if the fail indication is issued.

18. An apparatus according to claim 18, when dependent on any of claims 13 to 16, wherein the fan is stopping at the slowest fan speed commensurate with the issuing of the fail indication.

19. An apparatus according to claim 6, or any claim dependent thereon, wherein the processing circuitry is configured to continuously calculate an average of the signal and compare the average with the threshold level to determine whether to issue the pass indication or the fail indication.

20. An apparatus according to claim 7, or any claim dependent thereon, further including a temperature sensor, coupled to the processing circuitry and configured to measure a temperature of the exhaust gas; wherein the first period ceases when the processing circuitry determines that the heater device has raised the exhaust gas temperature to a predetermined temperature.

21. An apparatus according to claim 6, or any claim dependent thereon, wherein the user interface comprises a first indicator element, a second indicator element, a status element and a user actuatable element.

22. An apparatus according to claim 21, when dependent on claim 7, wherein during the first period the user interface is presented in a first form in which the status element is activated in a first manner.

23. An apparatus according to claim 22, wherein the status element comprises a first LED, e.g. amber in colour, and in the first manner the first LED flashes.

24. An apparatus according to claim 21, 22 or 23, when dependent on claim 8, wherein the second period is commenced in response to detecting actuation of the user actuatable element by a user.

25. An apparatus according to claim 24, wherein the user actuatable element comprises a button.

26. An apparatus according to any of claims 21 to 25, when dependent on claim 8, wherein between the end of the first period and the start of the second period the user interface is presented in a second form in which the status element is activated in a second manner.

27. An apparatus according to claim 26, wherein the status element comprises a first LED, e.g. amber in colour, and in the first manner the first LED is constantly illuminated.

28. An apparatus according to any of claims 21 to 27, when dependent on claim 8, wherein at the end of the second period the user interface is presented in a third form when a pass indication is issued, in which third form the first indicator element is activated and the status element is deactivated, or in a fourth form when a fail indication is issued, in which fourth form the second indicator element is activated and the status element is deactivated.

29. An apparatus according to claim 28, wherein the first indicator element comprises a second LED, e.g. green in colour, and the second indicator element comprises a third LED, e.g. red in colour.

30. An apparatus according to any of the preceding claims, wherein the exhaust gas is a diesel exhaust gas.

31. An apparatus according to any of the preceding claims, wherein one or both of the infrared emitter and infrared detector, or the infrared analysis device comprises a removable unit.

32. An apparatus according to claim 31, wherein the removable unit has identification element.

33. A particle filter testing station, comprising:
a measurement conduit including an insertion tube for insertion into the exhaust of a vehicle at idle and, communicatively coupled to the insertion tube, an exit tube for the exhaust of gases; and
an apparatus according to any of the preceding claims;
wherein the apparatus is fixedly or releasably coupled to the measurement conduit, whereby a portion of gases in the measurement conduit pass, in use, into the apparatus.

34. A particle filter testing station according to claim 33, when dependent upon claim 9, wherein the sample tube of the apparatus is coupled to the exit tube.

35. A particle filter testing station according to claim 34, wherein the sample tube of the apparatus is coupled to the exit tube at an angle thereto, for example at 90 degrees.

36. A particle filter testing station according to claim 34 or 35, wherein the sample tube has a smaller diameter than the exit tube.

37. A particle filter testing station according to any of claims 33 to 36, further comprising:
a base having a planar base surface;
an upright attached to the base and configured to be disposed in a substantially vertical position;
a movable support, the support being adapted to be releasably attached to the upright at one of a plurality of vertical positions thereon;
wherein the support is fixedly attached to the measurement conduit and/or configured to support the apparatus.

38. A particle filter testing station according to any of claims 33 to 37, further comprising a battery housing attached to or integral with the base, the battery housing being adapted to house a battery.

39. A method of operating an apparatus or station according to any preceding claim, the method including:
sampling the exhaust gas;
heating the exhaust gas prior to provision to the sample chamber;
analysing the exhaust gas by transmitting with the infrared transmitter an infrared beam into the exhaust gas in the sample chamber and receiving with the infrared receiver scattered infrared light from the exhaust gas in the sample chamber;
receiving with the infrared analysis device the signal from the infrared receiver; and
comparing the signal with the threshold level and issuing a pass indication if the exhaust gas is below the threshold level or issuing a fail indication if the exhaust gas is above the threshold level.

40. A method of analysing an exhaust gas of a vehicle, the method comprising:
providing apparatus comprising a sample chamber, a heating device and an infrared analysis device having an infrared transmitter and an infrared receiver;
receiving in the sample chamber the exhaust gas;
heating, using the heating device, the exhaust gas provided to the sample chamber;
transmitting, using the infrared transmitter, an infrared beam into the exhaust gas in the sample chamber;
receiving, using the infrared receiver, scattered infrared light from the exhaust gas in the sample chamber;
receiving at the infrared analysis device a signal from the infrared receiver and comparing it with a threshold level; and
issuing a pass indication if the exhaust gas is below the threshold level or issuing a fail indication if the exhaust gas is above the threshold level.

41. A method according to claim 40, wherein the threshold level corresponds to a change in signal level, compared to a base signal level when no exhaust gases are present in the sample chamber, equivalent to a predetermined density of particulates in the exhaust gas.

42. A method according to claim 39, wherein the predetermined density is in the range 0.02 to 0.5 mg/m³, or more preferably 0.04 to 0.25 mg/m³, or more preferably 0.04 to 0.125 mg/m³, or more preferably 0.04 to 0.0625 mg/m³.

43. A method according to claim 40, 41 or 42, and further including generating the signal using the infrared receiver based on infrared light scattered from particles in the exhaust gas having a particle size in the range 0.3 μm to 10 μm.

44. A method according to any of claims 40 to 43, wherein the signal is a voltage proportional to the density of particles in the exhaust gas.

45. A method according to any of claims 40 to 44, wherein the infrared analysis device includes processing circuitry, coupled to the infrared transmitter, the infrared receiver, the heating device and a user interface.

46. A method according to claim 45, further comprising operating, using the processing circuitry, the apparatus in a warm-up mode during a first period during which the heater device is activated.

47. A method according to claim 46, further comprising operating, using the processing circuitry, the apparatus subsequently in a test mode for a second period, during which the processing circuitry receives the signal(s) generated by the infrared receiver.

48. A method according to any of claims 40 to 47, further including providing a sample tube into which the exhaust gas flows, in use.

49. A method according to claim 48, further including disposing the heating device in a gas flow path between the sample tube and the sample chamber.

50. A method according to any of claims 40 to 49, further including providing a fan for delivering exhaust gas thereto.

51. A method according to claim 50, when dependent upon claim 49, wherein the fan is disposed in the gas flow path between the sample tube and the heater device.

52. A method according to claim 50 or 51, when dependent upon claim 45, wherein the processing circuitry is further coupled to the fan; the method further comprising operating, using the processing circuitry, the fan at one of a plurality of selectable fan speeds.

53. A method according to claim 52, when dependent upon claim 46 or 47, comprising (i) during the first period, (ii) prior to the second period and/or (iii) during a first sub-period at the beginning of the second period, operating the fan at a lowest fan speed using the processing circuitry.

54. A method according to claim 52, when dependent upon claim 47, further comprising, during the second period, switching the fan to successively higher ones of the selectable fan speeds, using the processing circuitry.

55. A method according to claim 54, wherein there are three selectable fan speeds, and the method comprises operating, using the processing circuitry, the fan at a lowest fan speed for a first sub-period at the beginning of the second period, at a medium fan speed for a second sub-period subsequent to the first sub-period, and at a highest fan speed for a third sub-period subsequent to the second sub-period.

56. A method according to claim 45, or any claim dependent thereon, wherein the method comprises, using the processing circuitry to continuously calculate an average of the signal, and compare the average with the threshold level to determine whether to issue the pass indication or the fail indication.

57. A method according to claim 46, or any claim dependent thereon, further including a temperature sensor coupled to the processing circuitry; wherein the method further comprises, using the processing circuitry, measuring a temperature of the exhaust gas and determining that the first period has ceased when it is determined that the exhaust gas has reached a predetermined temperature.

58. A method according to claim 45, or any claim dependent thereon, wherein the user interface comprises a first indicator element, a second indicator element, a status element and a user actuatable element.

59. A method according to claim 58, when dependent on claim 46, and further including, during the first period, presenting the user interface in a first form in which the status element is activated in a first manner.

60. A method according to claim 59, wherein the status element comprises a first LED, e.g. amber in colour, and in the first manner the first LED flashes.

61. A method according to claim 58, 59 or 60, when dependent on claim 47, further comprising detecting actuation of the user actuatable element by a user; wherein the second period is commenced in response to said actuation.

62. A method according to claim 61, wherein the user actuatable element comprises a button.

63. A method according to any of claims 58 to 62, when dependent on claim 47, further comprising, between the end of the first period and the start of the second period, presenting the user interface in a second form, in which the status element is activated in a second manner.

64. A method according to claim 63, wherein the status element comprises a first LED, e.g. amber in colour, and in the first manner the first LED is constantly illuminated.

65. A method according to any of claims 58 to 64, when dependent on claim 47, further comprising, at the end of the second period, presenting the user interface in a third form when a pass indication is issued, in which third form the first indicator element is activated and the status element is deactivated, or in a fourth form when a fail indication is issued, in which fourth form the second indicator element is activated and the status element is deactivated.

66. A method according to claim 65, wherein the first indicator element comprises a second LED, e.g. green in colour, and the second indicator element comprises a third LED, e.g. red in colour.

67. A method according to any of claims 40 to 66, wherein the exhaust gas is a diesel exhaust gas.

68. A method according to any of claims 39 to 67, and further including stopping the sampling of the exhaust gas if the fail indication is issued.

69. A method according to claim 68, when dependent on any of claims 50 to 55, and further including stopping the sampling of the exhaust gas by stopping the fan.

70. A method according to any of claims 40 to 69, when dependent on any of claims 52 to 55, and further including stopping the fan at the slowest fan speed commensurate with the issuing of the fail indication.

71. A software application operable to perform a method according to any of claims 39 to 70.
